(19) United States
(12) Patent Application Publication
(10) Pub. No.: US 2022/0324724 A1
(43) Pub. Date: Oct. 13, 2022

(54) DUAL-MODE PRESSURIZED WATER TREATMENT MEDIA VESSEL

(71) Applicants: John Lombardo, Plymouth, MA (US); Nick Dohmen, Redblluff, CA (US); Karen Tarbert, Houston, TX (US); Daniel Brooks, Beaver Falls, PA (US); Alexis Adair, Seven Hills, OH (US)

(72) Inventors: John Lombardo, Plymouth, MA (US); Nick Dohmen, Redblluff, CA (US); Karen Tarbert, Houston, TX (US); Daniel Brooks, Beaver Falls, PA (US); Alexis Adair, Seven Hills, OH (US)

(73) Assignee: Evoqua Water Technologies LLC, Pittsburgh, PA (US)

(21) Appl. No.: 17/228,702

(22) Filed: Apr. 13, 2021

(51) Int. Cl. C02F 1/00; C02F 1/28; C02F 1/42

(52) U.S. Cl. CPC C02F 1/008; C02F 1/283; C02F 1/42; C02F 1/006; C02F 2303/16; C02F 2101/36

(57) ABSTRACT

A pressurized media vessel system for water treatment is disclosed. The vessel can contain either granular activated carbon (GAC) or ion exchange (IX) resin. The system includes a flanged inlet to introduce process water to the vessel for treatment. The flanged inlet is configured to interchangeably attach to different distributors depending on a desired mode of operation. The vessel may be filled with a GAC bed in a first mode of operation and may be filled with an IX resin media bed in a second mode of operation.

### FIELD OF TECHNOLOGY

One or more aspects relate generally to the use of activated carbon and/or ion exchange resin media for water treatment.

### BACKGROUND

Activated carbon is widely used in gas purification, water purification, metal extraction, and sewage treatment among other applications. Activated carbon is generally a form of carbon that has been physically or chemically processed to increase its porosity and surface area available for adsorption and chemical reactions. Powdered activated carbon (PAC) and granular activated carbon (GAC) are among common forms.

Ion exchange resin is also used in various industrial applications including water treatment. Ion exchange resins are synthetic polymeric beads or granules that contain charged sites that can attract, from a solution, ions of the opposite charge, in order to remove or concentrate impurities.

Water treatment involving use of activated carbon or ion exchange resin typically occurs within a pressurized vessel.

### SUMMARY

In accordance with one or more aspects, a water treatment system is disclosed. The system may include a pressurized media vessel capable of effectively containing either granulated activated carbon (GAC) or ion exchange (IX) resin media, and a flanged inlet configured to introduce process water to the vessel for treatment. The flanged inlet is configured to removably receive a first distributor constructed and arranged to distribute the process water to a GAC bed housed within the vessel in a first mode of operation, and a second distributor constructed and arranged to distribute the process water to an IX resin media bed within the vessel in a second mode of operation.

In some aspects, the vessel houses a GAC bed in the first mode of operation, and the vessel houses an IX resin media bed in the second mode of operation. The first distributor may be a single point distributor. The second distributor may be a multi-point distributor. For example, the second distributor may be a four-point distributor.

In some aspects, the vessel may comprise at least one sample port. For example, the first vessel may comprise four sample ports.

In some aspects, the pressurized media vessel is a first pressurized media vessel, and the system further comprises a second pressurized media vessel. The first and second vessels may be arranged in parallel. The first vessel may house a GAC bed and the second vessel may house an IX resin media bed.

In some aspects, the vessel may house a GAC bed and an IX resin media bed arranged in series. The flanged inlet may be connected to the second distributor in such an arrangement.

In accordance with one or more aspects, a method of facilitating water treatment is disclosed. The method may involve providing a pressurized media vessel capable of effectively containing either granulated activated carbon (GAC) or ion exchange (IX) resin media, providing a flanged inlet configured to introduce process water to the vessel for treatment, wherein the flanged inlet is configured to removably receive a first distributor constructed and arranged to distribute the process water to a GAC bed housed within the vessel in a first mode of operation, and a second distributor constructed and arranged to distribute the process water to an IX resin media bed within the vessel in a second mode of operation, providing instructions to fill the vessel with either GAC or IX resin media to form the GAC bed or the IX resin media bed based on a desired mode of operation, and providing instructions to selectively attach the flanged inlet to either the first or the second distributor depending on the desired mode of operation.

In some aspects, the method may further comprise providing at least one of the first and second distributors. The first distributor may be a single point distributor. The second distributor may be a multi-point distributor, e.g. a four-point distributor.

In some aspects, the method may further comprise providing the GAC or the IX resin media. The method may further comprise regenerating the GAC or the IX resin media.

In some aspects, the pressurized media vessel is a first pressurized media vessel and the method further comprises providing a second pressurized media vessel.

In some aspects, the method may further comprise providing instructions to switch between the first and second distributors when the desired mode of operation changes.

In some aspects, the process water may comprise per- and polyfluoroalkyl substances (PFAS).

In accordance with one or more embodiments, a method of treating water is disclosed. The method may involve analyzing process water to be treated, selecting a desired mode of operation based on the process water analysis, wherein a first mode of operation involves treating process water with granulated activated carbon (GAC) media and a second mode of operation involves treating process water with ion exchange (IX) resin media, selectively filling a pressurized vessel with GAC or IX resin media depending on the desired mode of operation, selectively attaching a first or second distributor to a flanged inlet of the pressurized vessel depending on the desired mode of operation, and fluidly connecting a source of the process water to the flanged inlet of the pressurized vessel for treatment.

In some aspects, the first mode of operation is selected when analyzed process water contains long-chain PFAS, and the second mode of operation is selected when analyzed process water contains short-chain PFAS.

In some aspects, the first distributor is single point distributor in the first mode of operation, and the second distributor is a multi-point, e.g. four-point, distributor in the second mode of operation.

In some aspects, the method may further comprise changing the desired mode of operation.

The disclosure contemplates all combinations of any one or more of the foregoing aspects and/or embodiments, as well as combinations with any one or more of the embodiments set forth in the detailed description and any examples.

### BRIEF DESCRIPTION OF THE DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1a presents a schematic of a water treatment system including a pressurized media vessel in accordance with one or more embodiments;

FIG. 1b presents a partial inside view of a top of the pressurized media vessel of FIG. 1a;

FIG. 2a presents a schematic of a pressurized media vessel including a first distributor in accordance with one or more embodiments;

FIG. 2b presents a detailed view of the first distributor of FIG. 2a;

FIG. 3a presents a schematic of a pressurized media vessel including a second distributor in accordance with one or more embodiments;

FIG. 3b presents a detailed view of the second distributor of FIG. 3a; and

FIG. 4 presents a schematic of a water treatment system including first and second pressurized media vessels in accordance with one or more embodiments.

It will be recognized by the person of ordinary skill in the art, given the benefit of this disclosure, that the figures are purely for illustrative purposes. Other features may be present in the embodiments disclosed herein without departing from the scope of the description.

### DETAILED DESCRIPTION

Carbon and resin media are both widely used for the removal of organic and inorganic contaminates from water sources. It may be desirable to have flexibility in terms of what type of media is used for water treatment within a pressurized media vessel. For example, the source and/or constituents of the process water to be treated may be a relevant factor. Various federal, state and/or municipal regulations may also be factors. Market conditions may also be a controlling factor. These factors may be variable and therefore a preferred water treatment approach may change over time.

In accordance with one or more embodiments, a pressurized media vessel may be configured to effectively contain an activated carbon or an ion exchange (IX) resin media bed for water treatment. Beneficially, a flanged inlet may provide flexibility depending on a desired mode of operation in terms of implementing activated carbon or IX resin media. Specifically, various process water distributors may be interchangeably received by the flanged inlet to accommodate a desired mode of operation as described further herein.

In accordance with one or more embodiments, activated carbon may be used as an adsorbent to treat water. In some embodiments, the activated carbon may be made from bituminous coal, coconut shell, or anthracite coal. The activated carbon may generally be a virgin or a regenerated activated carbon. In some embodiments, the activated carbon may be a modified activated carbon. The activated carbon may be present in various forms, i.e. a granular activated carbon (GAC) or a powdered activated carbon (PAC). Various activated carbon media for water treatment are known to those of ordinary skill in the art. In at least some non-limiting embodiments, the media may be an activated carbon as described in U.S. Pat. No. 8,932,984 and/or U.S. Pat. No. 9,914,110, both to Evoqua Water Technologies LLC.

In accordance with one or more embodiments, IX resin media may be used to treat water. Ion exchange is a conventional water treatment method where one or more undesirable ionic contaminants are removed from water by exchange with another non-objectionable, or less objectionable ionic substance. Ions present on an insoluble IX resin matrix effectively swap places with ions of a similar charge that are present in a surrounding solution. The IX resin used may be selected based on various operational parameters such as the source, flow rate and/or constituents of the process water to be treated or desired properties of the resulting treated water. In some embodiments, the IX resin may be a cation exchange resin. In other embodiments, the IX resin may be an anion exchange resin. Mixed resin beds may also be implemented. The IX resin may be in the form of beads or a powder material. The IX resin may generally be a virgin or a regenerated IX resin. In some embodiments, the IX resin may be a modified IX resin. Various IX resins for water treatment are known to those of ordinary skill in the art.

In accordance with one or more non-limiting embodiments, a process water, e.g. wastewater, may be contacted with a media in a pressurized vessel for treatment. The process water may be introduced to the vessel via a semi-batch or continuous process. In some non-limiting embodiments, fixed bed, expanded bed, moving bed or fluidized bed adsorption processes may be used within the vessel. A GAC media bed may be contained within the pressurized vessel for such adsorption processes. In other non-limiting embodiments, an IX resin bed may be contained within the pressurized vessel. Various factors may impact vessel design including particle size, column diameter, flow rate of incoming process water, desired residence time, adsorption bed height, pressure drop and breakthrough time. Treated water may generally be collected at an outlet at the bottom of the vessel.

With reference to embodiments involving GAC media, as the process water moves through the media bed, pollutants may be adsorbed via movement from the water to the carbon bed. In some embodiments, the overall adsorption process may be dominated by a mass transfer step from the wastewater bulk to the surface of the GAC media, through the boundary layer surrounding the GAC particles. Internal diffusion through the carbon pores and adsorption onto the surface of the particle may also be involved. Spent activated carbon may be regenerated, e.g. via a thermal process. With reference to embodiments involving IX media, pollutants may be exchanged with ions of the IX media as the process water moves through the media bed. Exhausted IX media may be regenerated, e.g. with a brine solution.

In accordance with one or more embodiments, the process water to be treated may include various undesirable constituents. In some embodiments, media treatment may be applied for the removal of negatively charged contaminant molecules. Notable amongst such molecules are poly- and perfluorinated compounds (PFCs) that are present in wastewater. In some non-limiting embodiments, media treatment may be applied for the adsorption of per- and polyfluoroalkyl substances (PFAS) in water. In some embodiments, cationic PFAS levels in water may be addressed. In some specific non-limiting embodiments, perfluorooctanoate (PFOA) and/or perfluorooctane sulfonate (PFOS) may be removed from water via media treatment. Other target constituents are widely recognized by those skilled in the relevant art.

In accordance with one or more embodiments, the pressurized vessel may include an inlet for delivering process water to the pressurized vessel for treatment. The inlet may be a flanged inlet to provide flexibility in terms of operation as described herein. The pressurized vessel may generally be constructed and arranged to effectively contain GAC or IX resin media. The GAC or IX resin media may be housed within the pressurized vessel. Various arrangements and methods for filling the pressurized vessel with media are commonly known to those of skill in the art. The GAC or IX resin may generally form one or more media beds within the pressurized vessel through which process water may flow during a treatment operation. Number and depth of media beds within the vessel may generally control residence time therein. In some embodiments, the pressurized vessel may house one or more GAC media beds. In other embodiments, the pressurized vessel may house one or more IX media beds. In still other embodiments, the pressurized vessel may house both GAC and IX media beds in series, such as in a layered arrangement.

In some embodiments, a first mode of operation may involve using GAC media for water treatment. The pressurized media vessel may house GAC media in the first mode of operation. A second mode of operation may involve using IX media for water treatment. The pressurized media vessel may house IX media in the second mode of operation. In at least some embodiments, the water treatment system may provide flexibility in terms of switching between the first and second modes of operation using the same pressurized media vessel. The overall system may be designed such that the media vessel may be used in conjunction with either GAC or IX media. A desired mode of operation may be selected based on various operational, regulatory or other parameters. For example, various regulations may dictate IX resin treatment for short-chain PFAS but GAC treatment for long-chain PFAS. The disclosed systems are therefore adaptable as a safeguard to address various evolving factors including but not limited to an evolving regulatory landscape.

For example, the system may be operated in the first mode of operation for a first period of time and then switched to the second mode of operation for a second period of time. Likewise, the system may be operated in the second mode of operation for a first period of time and then switched to the first mode of operation for a second period of time. In this way, the system may accommodate any change in a desired mode of operation. For example, a more widely accepted media may be used in the first mode of operation and then a more high-tech media, such as one requiring more piloting, may be used in the second mode of operation.

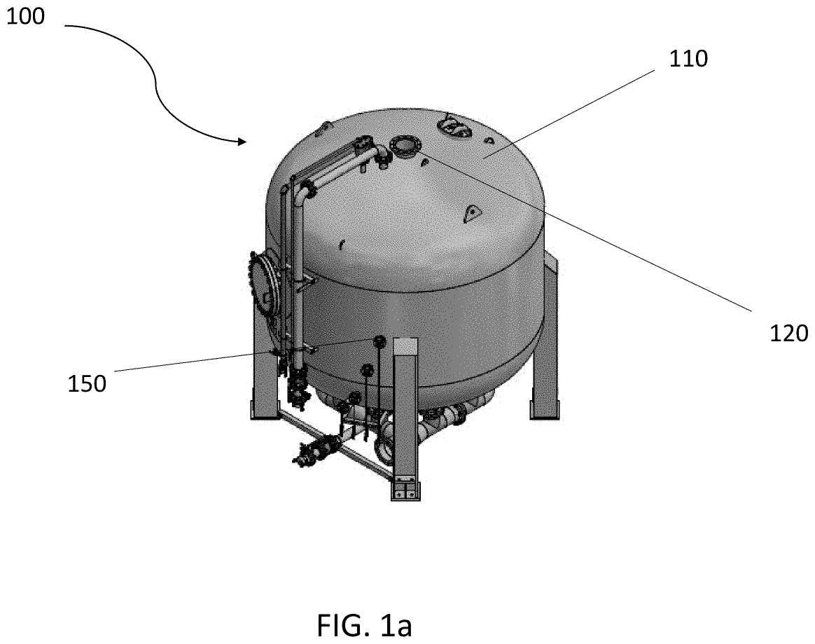

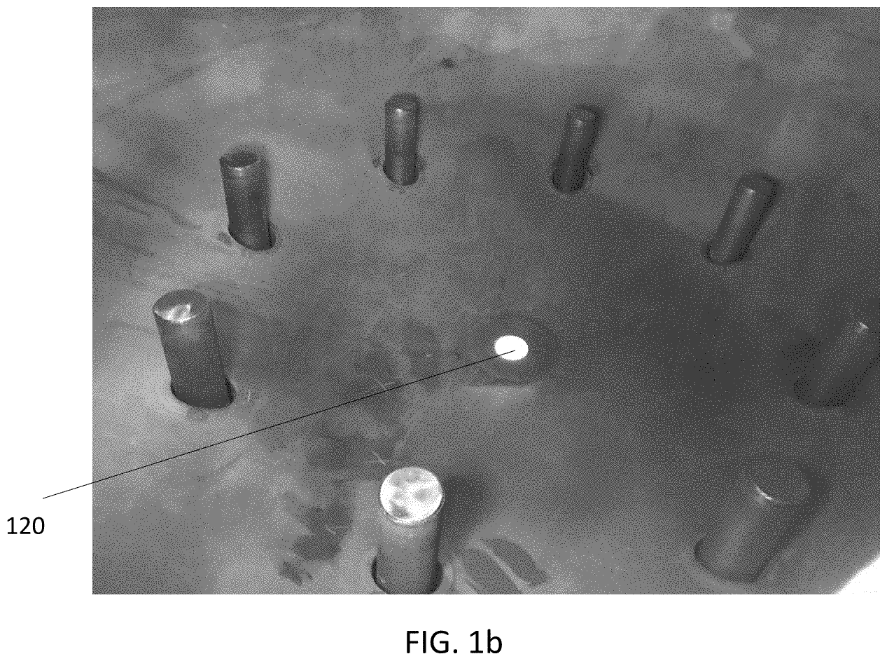

FIG. 1a presents a schematic of a water treatment system 100 including pressurized media vessel 110 in accordance with one or more embodiments. Inlet 120 is configured to deliver process water to the pressurized vessel 110 for treatment. FIG. 1b presents a view of the top of the pressurized vessel from the inside. Inlet 120 is present to facilitate introduction of process water and enable operational flexibility of the system as described herein.

In accordance with one or more embodiments, a distributor may be fluidly connected to the inlet within the pressurized media vessel. The distributor may be removably received by the flanged inlet in accordance with various embodiments. Different types of distributors may be desirable depending on various operational parameters within the pressurized media vessel. Choice of media may be a significant factor in determining the appropriate distributor. Thus, mode of operation in terms of using GAC or IX resin may generally inform the type of implemented distributor. In at least some embodiments, distributors may not be interchangeable with specific distributors instead needed for effective treatment. It may generally be desirable to achieve effective distribution across a media bed for water treatment and the most effective approach may vary depending on the type of media. Specifically, the introduction of process water to a media bed may be associated with different parameters and considerations depending on the type of media. For example, the potential for undesirable channeling or pressure gain may be an issue with certain types of media such as IX media, but of less concern with other types of media such as GAC. Some forms of media, such as IX media, may be more susceptible to undesirable shifting or movement within the vessel and the choice of distributor may ameliorate such concerns. The design of the distributor may impact process water distribution and/or flow rate across the media bed. The size and shape of the distributor may be selected based on the geometry of the vessel and/or media bed(s) among other operational parameters including desired distribution as understood by those skilled in the art.

Conventionally, a pressurized media vessel is generally designated for use with a specific type of media, in large part, by virtue of its incorporated distribution system. For example, a GAC pressurized media vessel would conventionally be equipped with one type of distributor, and an IX pressurized media vessel would conventionally be equipped with another type of distributor. Beneficially, in accordance with one or more embodiments, a single pressurized media vessel can be used with either GAC or IX resin media by accommodating various types of distributors. The flanged inlet may removably receive various distributors to facilitate this flexibility in accordance with various embodiment disclosed herein.

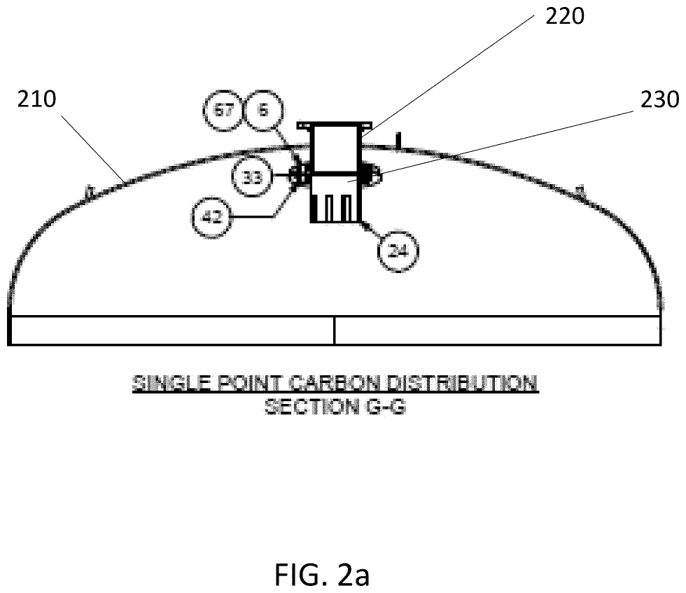

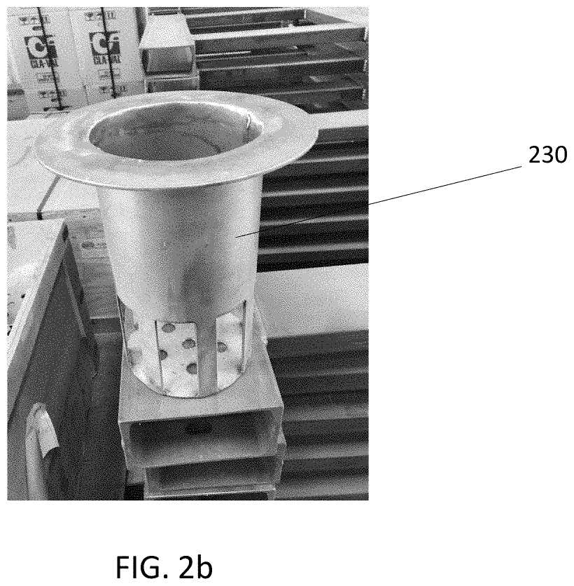

Beneficially, the disclosed systems may offer the option of effectively switching from one media to another by changing the distributor at the flanged inlet. In accordance with one or more embodiments, a first distributor may be configured for use with GAC media. Various distributors designed for effective operation with GAC media beds are commonly known to those skilled in the art. Even distribution may generally be of less concern in connection with GAC media. In a least some embodiments, these first distributors may generally be single point distributors. FIG. 2a presents vessel 210 including first distributor 230 at flanged inlet 220. FIG. 2b presents a non-limiting embodiment of the first distributor 230 in accordance with one or more embodiments.

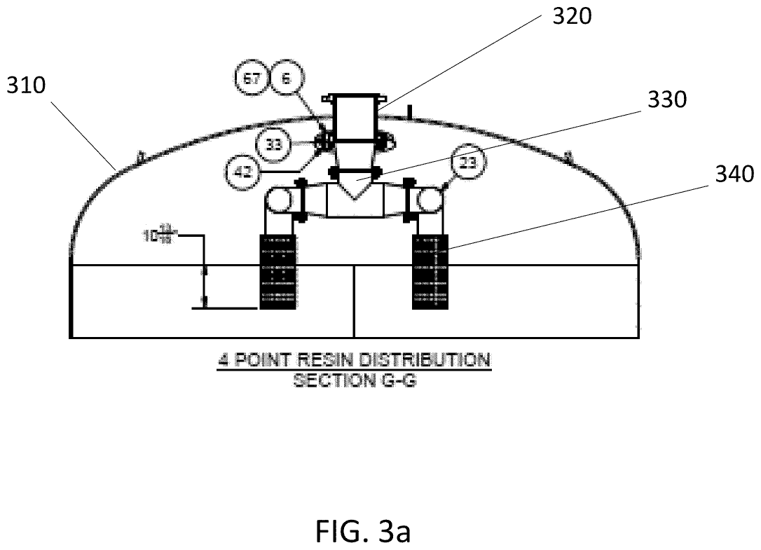

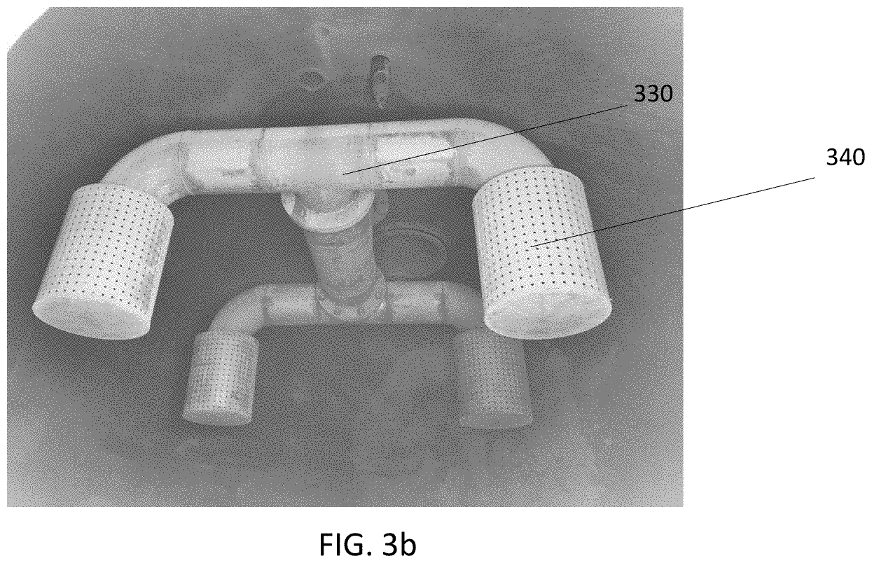

In accordance with one or more embodiments, a second distributor may be configured for use with IX media. Various distributors designed for effective operation with IX media beds are commonly known to those skilled in the art. In some embodiments, these second distributors may generally be multi-point distributors to achieve substantially uniform distribution across a media bed, such as to prevent resin movement therein. In at least some embodiments, the second distributor may include three or more distribution points. In some non-limiting embodiments, the second distributor is a four-point distributor. In some embodiments, the various distribution points of the second distributor may be generally be equidistant or otherwise strategically arranged. In at least some embodiments, the arrangement of distribution points or “perforated cans” may resemble a chandelier. FIG. 3a presents vessel 310 including first distributor 330 at flanged inlet 320. FIG. 3b presents a non-limiting embodiment of the second distributor 330 including perforated cans 340 in accordance with one or more embodiments. In some embodiments, first and/or second distributors may further include diffusers to promote uniform distribution.

In some non-limiting embodiments, a vessel may house one or more GAC media beds and one or more IX media beds. Due to the unique design constraints with respect to the importance of uniform distribution with IX media, such a hybrid system would preferably include the second distributor including multiple distribution points.

In accordance with one or more embodiments, the pressurized media vessel may include various sampling ports for monitoring a water treatment process. In some embodiments, the vessel may include two, three, four or more sample ports. The sample ports may be strategically positioned within the vessel, such as at different depths. In at least some embodiments, at least one sample port may be an extra depth sample port. FIG. 1a presents vessel 110 including a plurality of sampling ports 150.

In accordance with one or more embodiments, treatment of water may be facilitated. A water treatment system may be provided including at least one pressurized vessel. A flanged inlet may be provided for the vessel. The flanged inlet may be configured to introduce process water to the vessel for treatment. The flanged inlet may be configured to removably receive a first distributor constructed and arranged to distribute the process water to a GAC bed housed within the vessel in a first mode of operation, and a second distributor constructed and arranged to distribute the process water to an IX resin media bed within the vessel in a second mode of operation.

In some embodiments, at least one of the first and second distributors may be provided. The GAC and/or the IX resin media may also be provided. The GAC and/or the IX resin media may be regenerated. Instructions to switch between the first and second distributors when the desired mode of operation changes may be provided. Instructions to fluidly attach a source of the process water to the flanged inlet may still further be provided. In at least some embodiments, a second pressurized media vessel may also be provided.

In accordance with one or more embodiments, a water treatment kit may include at least one pressurized vessel and at least one of the first and second distributors. GAC and/or IX media may also be included.

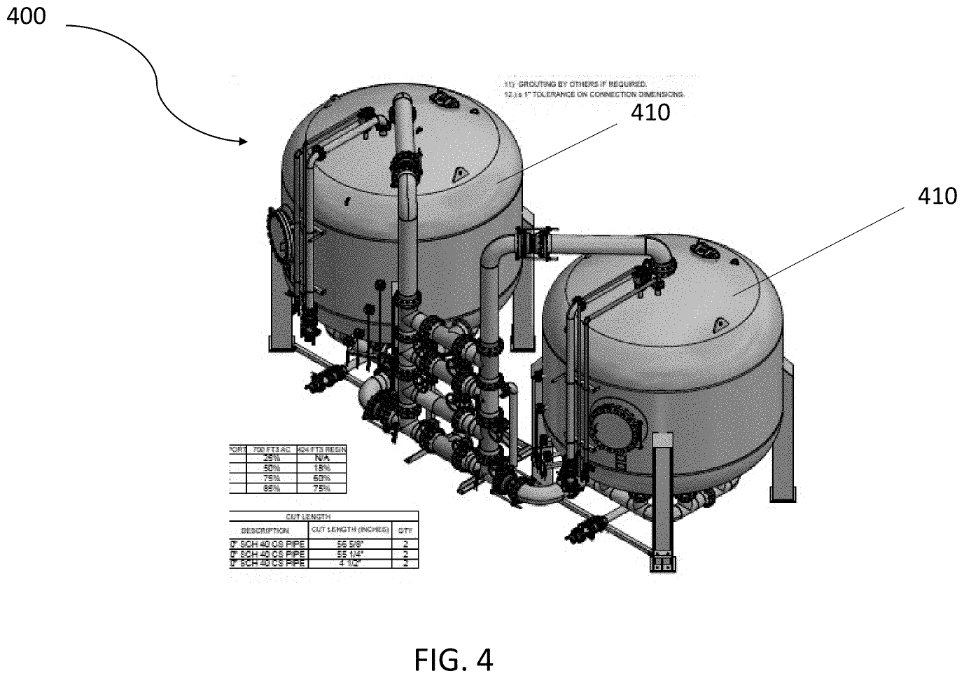

In accordance with one or more embodiments, a water treatment system can include two or more pressurized media vessels. The multiple media vessels may be arranged in parallel or in series. In parallel, the two vessels may cooperate, such as front and back or lead and lag. In series, a downstream vessel may serve as a polishing unit operation. In the non-limiting case of two-vessel system, both may house GAC, both may house IX resin, or each vessel can house a different media, for example one GAC and one IX resin or each housing a different type of IX resin. FIG. 4 presents water treatment system 400 including first and second pressurized media vessels 410.

In operation, an operator my determine whether to setup the system for GAC or IX treatment. If GAC is selected, the first mode of operation may be pursued. A first distributor would be removably attached to the flanged inlet of the pressure vessel. The pressure vessel would be filled with GAC media for water treatment. If IX media is selected, the second mode of operation may be pursued. A second distributor would be removably attached the flanged inlet of the pressure vessel. The pressure vessel would be filed with IX media for water treatment. After a period of time, the operator may determine a different desired mode of operation. In this case, the vessel would be drained and the GAC or IX media would be removed and swapped for the other. Likewise, the first or second distributor would be separated from the flanged inlet and swapped for the other prior to resuming water treatment operation. As described herein, changing market conditions, regulations or target constituents may influence selection of a desired mode of operation over time.

In accordance with one or more embodiments, treated water produced with the disclosed systems and methods may be potable. Treated water produced with the disclosed systems and methods may meet various federal, state and/or municipal regulatory requirements. In at least some embodiments, the systems and methods described herein may find utility in the municipal water treatment market and may be used to produce drinking water. The disclosed systems and methods may be integrated with one or more pre- or post-treatment unit operations.

Those skilled in the art should appreciate that the parameters and configurations described herein are exemplary and that actual parameters and/or configurations will depend on the specific application in which the disclosed methods and materials are used. Those skilled in the art should also recognize or be able to ascertain, using no more than routine experimentation, equivalents to the specific embodiments disclosed. It is therefore to be understood that the embodiments described herein are presented by way of example only and that, within the scope of the appended claims and equivalents thereto; the disclosed embodiments may be practiced otherwise than as specifically described. The present systems and methods are directed to each individual feature, system, or method described herein. In addition, any combination of two or more such features, systems, or methods, if such features, systems, or methods are not mutually inconsistent, is included within the scope of the present disclosure. The steps of the methods disclosed herein may be performed in the order illustrated or in alternate orders and the methods may include additional or alternative acts or may be performed with one or more of the illustrated acts omitted.

Further, it is to be appreciated that various alterations, modifications, and improvements will readily occur to those skilled in the art. Such alterations, modifications, and improvements are intended to be part of this disclosure and are intended to be within the spirit and scope of the disclosure. In other instances, an existing facility may be modified to utilize or incorporate any one or more aspects of the methods and systems described herein. Accordingly, the foregoing description and figures are by way of example only. Further the depictions in the figures do not limit the disclosures to the particularly illustrated representations.

The phraseology and terminology used herein is for the purpose of description and should not be regarded as limiting. As used herein, the term “plurality” refers to two or more items or components. The terms “comprising,” “including,” “carrying,” “having,” “containing,” and “involving,” whether in the written description or the claims and the like, are open-ended terms, i.e., to mean “including but not limited to.” Thus, the use of such terms is meant to encompass the items listed thereafter, and equivalents thereof, as well as additional items. Only the transitional phrases “consisting of” and “consisting essentially of,” are closed or semi-closed transitional phrases, respectively, with respect to the claims. Use of ordinal terms such as “first,” “second,” “third,” and the like in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

While exemplary embodiments of the disclosure have been disclosed, many modifications, additions, and deletions may be made therein without departing from the spirit and scope of the disclosure and its equivalents, as set forth in the following claims.

What is claimed is:

1. A water treatment system, comprising:
a pressurized media vessel capable of effectively containing either granulated activated carbon (GAC) or ion exchange (IX) resin media; and
a flanged inlet configured to introduce process water to the vessel for treatment, wherein the flanged inlet is configured to removably receive a first distributor constructed and arranged to distribute the process water to a GAC bed housed within the vessel in a first mode of operation, and a second distributor constructed and arranged to distribute the process water to an IX resin media bed within the vessel in a second mode of operation.

2. The system of claim 1, wherein the vessel houses a GAC bed in the first mode of operation, and wherein the vessel houses an IX resin media bed in the second mode of operation.

3. The system of claim 1, wherein the first distributor is a single point distributor.

4. The system of claim 1, wherein the second distributor is a multi-point distributor.

5. The system of claim 4, wherein the second distributor is a four-point distributor.

6. The system of claim 1, wherein the vessel comprises at least one sample port.

7. The system of claim 6, wherein the first vessel comprises four sample ports.

8. The system of claim 1, wherein the pressurized media vessel is a first pressurized media vessel, and wherein the system further comprises a second pressurized media vessel.

9. The system of claim 8, wherein the first and second vessels are arranged in parallel.

10. The system of claim 8, wherein the first vessel houses a GAC bed and the second vessel houses an IX resin media bed.

11. The system of claim 10, wherein the vessel houses a GAC bed and an IX resin media bed arranged in series.

12. The system of claim 11, wherein the flanged inlet is connected to the second distributor.

13. A method of facilitating water treatment, comprising:
providing a pressurized media vessel capable of effectively containing either granulated activated carbon (GAC) or ion exchange (IX) resin media;
providing a flanged inlet configured to introduce process water to the vessel for treatment, wherein the flanged inlet is configured to removably receive a first distributor constructed and arranged to distribute the process water to a GAC bed housed within the vessel in a first mode of operation, and a second distributor constructed and arranged to distribute the process water to an IX resin media bed within the vessel in a second mode of operation;
providing instructions to fill the vessel with either GAC or IX resin media to form the GAC bed or the IX resin media bed based on a desired mode of operation; and
providing instructions to selectively attach the flanged inlet to either the first or the second distributor depending on the desired mode of operation.

14. The method of claim 13, further comprising providing at least one of the first and second distributors.

15. The method of claim 14, wherein the first distributor is a single point distributor.

16. The system of claim 14, wherein the second distributor is a multi-point distributor, e.g. a four-point distributor.

17. The method of claim 13, further comprising providing the GAC or the IX resin media.

18. The method of claim 17, further comprising regenerating the GAC or the IX resin media.

19. The method of claim 13, wherein the pressurized media vessel is a first pressurized media vessel, and wherein the method further comprises providing a second pressurized media vessel.

20. The method of claim 13, further comprising providing instructions to switch between the first and second distributors when the desired mode of operation changes.

21. The method of claim 13, wherein the process water comprises per- and polyfluoroalkyl substances (PFAS).

22. A method of treating water, comprising:
analyzing process water to be treated;
selecting a desired mode of operation based on the process water analysis, wherein a first mode of operation involves treating process water with granulated activated carbon (GAC) media and a second mode of operation involves treating process water with ion exchange (IX) resin media;
selectively filling a pressurized vessel with GAC or IX resin media depending on the desired mode of operation;
selectively attaching a first or second distributor to a flanged inlet of the pressurized vessel depending on the desired mode of operation; and
fluidly connecting a source of the process water to the flanged inlet of the pressurized vessel for treatment.

23. The method of claim 22, wherein the first mode of operation is selected when analyzed process water contains long-chain PFAS, and wherein the second mode of operation is selected when analyzed process water contains short-chain PFAS.

24. The method of claim 22, wherein the first distributor is single point distributor in the first mode of operation, and wherein the second distributor is a multi-point, e.g. four-point, distributor in the second mode of operation.

25. The method of claim 22, further comprising changing the desired mode of operation.
